(19) United States
(12) Patent Application Publication
(10) Pub. No.: US 2006/0072422 A1
(43) Pub. Date: Apr. 6, 2006

(54) Scanning device including an optical filter

(76) Inventors: Robert Frans Maria Hendriks, Eindhoven (NL); Johannes Schleipen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/535,463

(22) PCT Filed: Oct. 28, 2003
(86) PCT No.: PCT/IB03/04811

§ 371 Date: May 17, 2005

(30) Foreign Application Priority Data
Nov. 20, 2002 (EP) 02079818.7

(51) Int. Cl. G11B 7/00

(52) U.S. Cl. 369/112.01; 369/44.12

(57) ABSTRACT

An optical scanning device (1; 100) for scanning an information layer (4) of an optical record carrier (2; 102). The device comprises a radiation source (11; 111) for generating a radiation beam (12, 15, 20; 112, 115, 120), an objective system (18; 118) for converging the radiation beam on the information layer (4), and an optical filter (200) for regulating the intensity profile of the radiation beam. The filter has an optical axis (119) and comprises a saturable absorber (206) having an absorption that saturates at a threshold incident radiation intensity. For incident radiation beams of intensity less than the threshold, the absorption of the absorber decreases with distance away from the axis.

The present invention relates to an optical scanning device for scanning an optical record carrier, to an optical filter suitable for, but not limited to, regulating the intensity profile of a radiation beam in such a scanning device, and to methods for manufacturing such a device and such a filter and to a method for regulating the intensity profile of a radiation beam using such a filter.

In optical storage, reading and writing place different requirements on the radiation spot used to scan the record carrier. Examples of optical record carriers include CD's (Compact Discs) and DVD's (Digital Versatile Discs).

When reading information from the carrier, the radiation spot size determines the mark size that is readable. It is therefore desirable that the spot size is small, so as to allow the reading of small mark sizes on carriers having a high information density.

When writing information to a carrier, the radiation spot size is less critical. Rather, it is desirable that the optical path from the radiation source to the information carrier is efficient (i.e. low loss). This reduces the power consumption of the radiation source, a factor which is particularly significant for portable applications. Further, radiation sources are typically lasers. The lifetime of a laser increases if the light path between the laser and the record carrier is efficient, as the laser can be operated at lower drive currents to generate the desired radiation intensity incident on the record carrier.

In order to obtain a small spot size for reading, it is desirable that the intensity distribution of the optical beam incident on the objective lens system is relative flat. In other words, for reading, it is desirable that the radiation beam has a high rim-intensity (rim-intensity is the relative intensity of the beam at the edge of the objective system compared to the intensity along the optical axis).

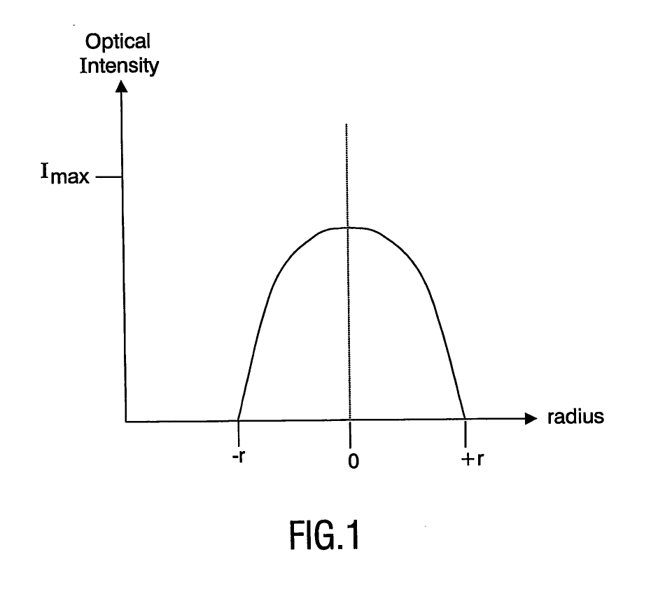

FIG. 1 illustrates the typical optical intensity distribution across the width of a radiation beam of radius r. It will be seen that the highest optical intensity Iₘₐₓ is at the centre of the beam (i.e. along the optical axis in a typical scanning device), falling off relatively sharply with distance away from the beam centre. The rim intensity of the beam could be increased for reading applications by placing an absorbing spatial filter in the beam, so as to reduce transmission of central parts of the beam. However, such a filter would decrease the efficiency of the total light path, making the use of such a filter undesirable for writing applications.

It is an aim of embodiments of the present invention to provide an optical filter suitable for addressing at least one of the problems of the prior art, whether referred to herein or otherwise.

It is an aim of embodiments of the present invention to provide an optical filter suitable for providing a high rim-intensity for reading radiation beams, whilst providing low absorption of writing radiation beams.

In a first aspect the present invention provides an optical scanning device for scanning an information layer of an optical record carrier, the device comprising a radiation source for generating a radiation beam, an objective system for converging the radiation beam on the information layer, and an optical filter for regulating the intensity profile of the radiation beam, the filter having an optical axis and comprising a saturable absorber having an absorption that saturates at a threshold incident radiation intensity, the absorption of the absorber decreasing with distance away from the axis for incident radiation beams of intensity less than the threshold.

By utilising such a filter, the rim-intensity of a reading radiation beam (at an intensity less than the threshold) can be increased. Further, if a writing radiation beam is provided at a higher intensity than the threshold, then the absorber will saturate, such that the filter represents a relatively low loss optical transmission path. This filter can be positioned before the objective system, but also after the objective system. If positioned after, the filter is preferably positioned at a very small distance after the objective system.

In another aspect, the present invention provides an optical filter for regulating the intensity profile of a radiation beam, the filter having an optical axis and comprising a saturable absorber having an absorption that saturates at a threshold incident radiation intensity, the absorber having an absorption that decreases with distance away from the optical axis for incident radiation beams of intensity less than the threshold.

In a further aspect, the present invention provides a method for manufacturing an optical filter for regulating the intensity profile of a radiation beam, the filter having an optical axis and comprising a saturable absorber having an absorption that saturates at a threshold incident radiation intensity, the absorber having an absorption that decreases with distance away from the optical axis for incident radiation beams of intensity less than the threshold, the method comprising the step of: forming a non-uniform layer of saturable absorber upon a transparent substrate.

In another aspect, the present invention provides a method of manufacturing an optical scanning device for scanning an information layer of an optical record carrier, the method comprising the steps of: providing a radiation source for generating a radiation beam; providing a lens system for converging the radiation beam on the information layer, and providing an optical filter or regulating the intensity profile of the radiation beam, the filter having an optical axis and comprising a saturable absorber having an absorption that saturates at a threshold incident radiation intensity, the absorption of the absorber decreasing with distance away from the axis for incident radiation beams of intensity less than the threshold.

In another aspect, the present invention provides a method for regulating the intensity profile of a radiation beam using a filter having an optical axis and comprising a saturable absorber having an absorption that saturates at a threshold incident radiation intensity, the absorber having an absorption that-decreases with-distance away from the optical axis for incident radiation beams of intensity less than the threshold.

Other aspects of the invention will be apparent from the dependent claims.

For a better understanding of the invention, and to show how embodiments of the same may be carried into effect, reference will now be made, by way of example, to the accompanying diagrammatic drawings in which:

FIG. 1 illustrates the optical intensity profile over a cross section of a radiation beam;

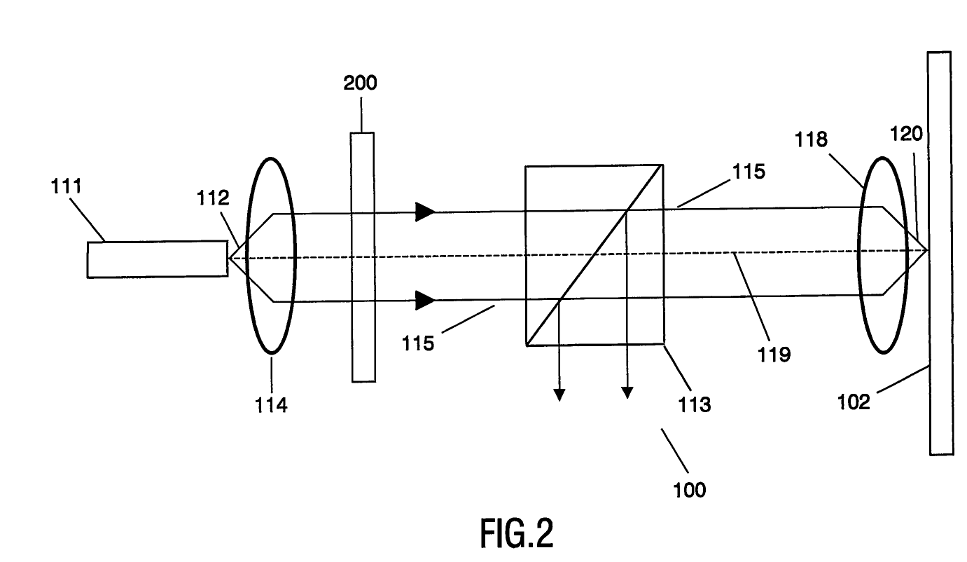

FIG. 2 shows a device for scanning an optical record carrier including an optical filter in accordance with an embodiment of the present invention;

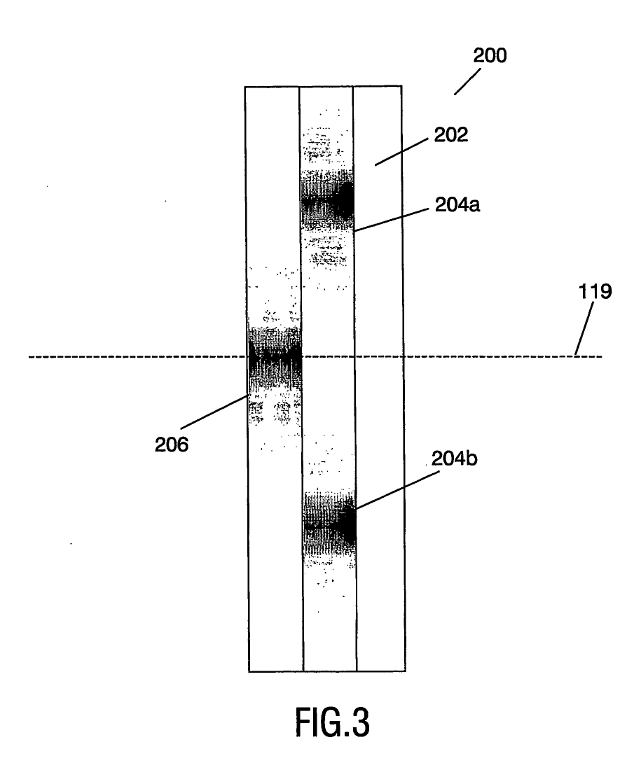

FIG. 3 shows an optical filter in accordance with an embodiment of the present invention;

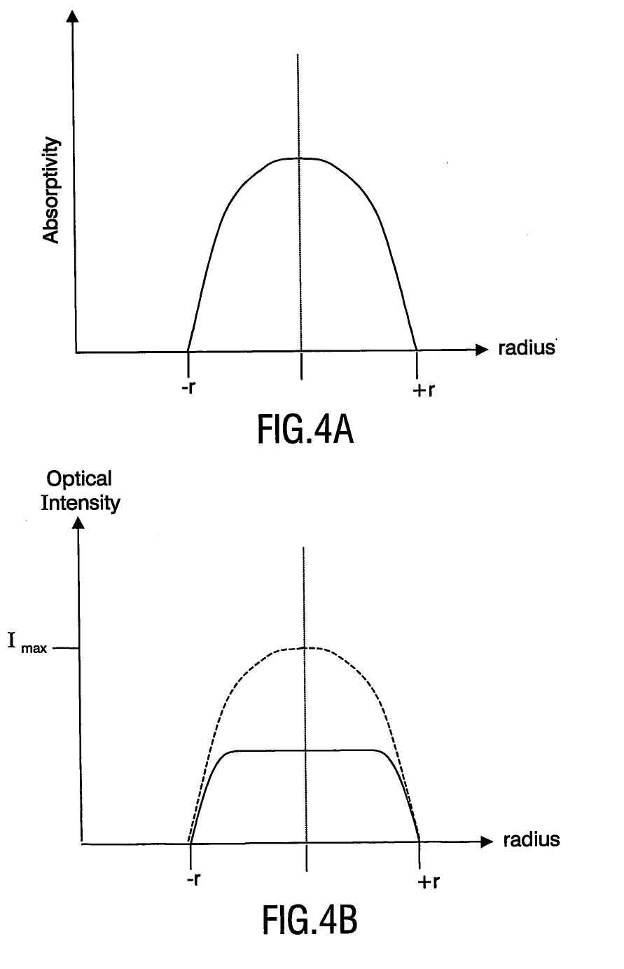

FIG. 4A illustrates the absorptivity of the optical filter across the width of the radiation beam, for a radiation beam intensity less than the saturation threshold;

FIG. 4B illustrates the optical intensity across the width of the radiation beam for a beam incident on the filter (dotted line) and the beam transmitted through the filter (solid line) at an incident beam intensity less than the saturation threshold;

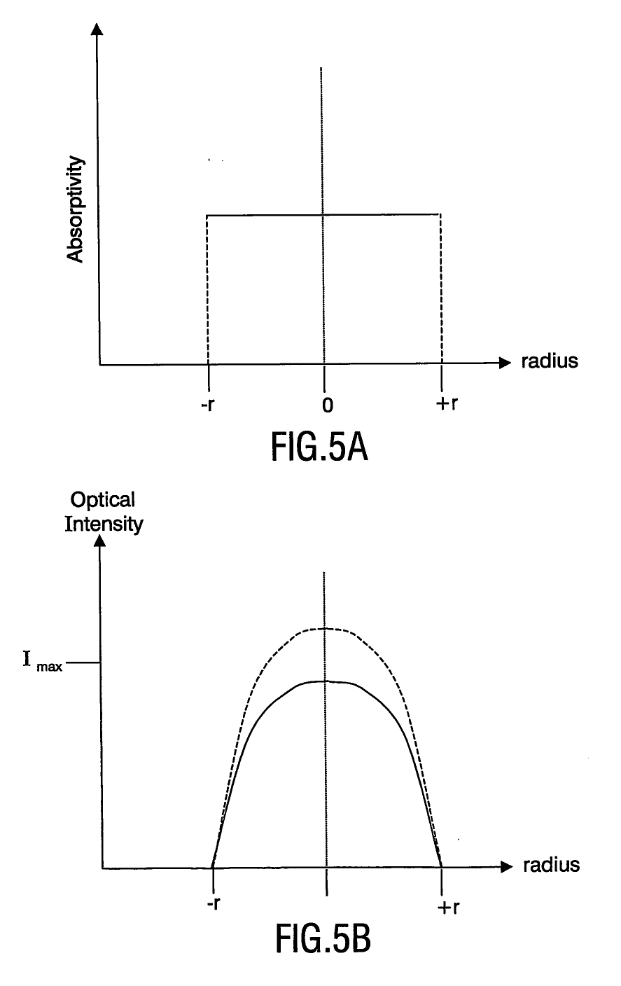

FIG. 5A illustrates the absorptivity of the optical filter across the width of the radiation beam, for a radiation beam intensity higher than the saturation threshold,

FIG. 5B illustrates the optical intensity across the width of the radiation beam for a beam incident on the filter (dotted line) and the beam transmitted through the filter (solid line) at an incident beam intensity higher than the saturation threshold; and

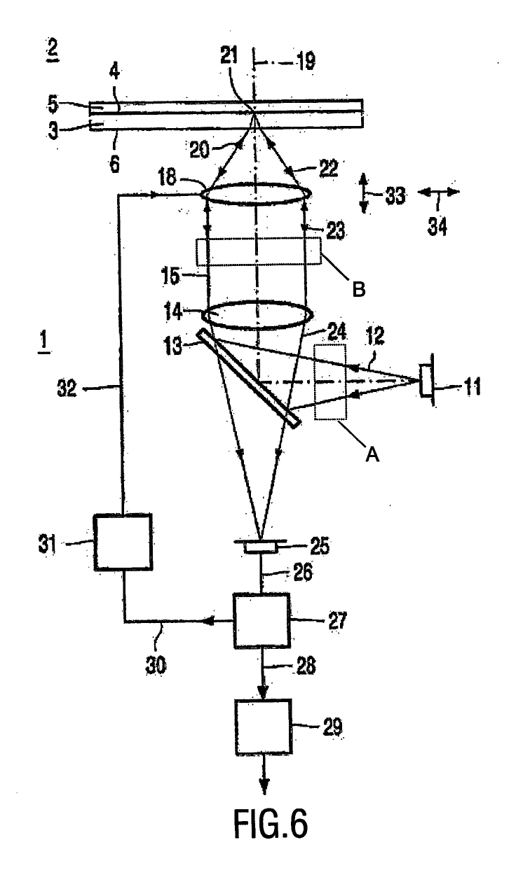

FIG. 6 shows a device for scanning an optical record carrier indicating two potential positions for placing an optical filter in accordance with an embodiment of the present invention.

FIG. 2 shows a device 100 for scanning an optical record carrier 102 in accordance with an embodiment of the present invention. The device comprises a radiation source 111, which in this particular example is a laser. The radiation source is arranged to output radiation beams at least two levels of intensity.

The first level of intensity is, when ultimately incident upon the surface of the record carrier 102, sufficient to read information from the record carrier. Typically, this corresponds to a collimated beam intensity (pupil intensity) of approximately 8 mW/cm².

The second, higher, intensity is suitable, when incident upon an appropriate record carrier, to write information to the record carrier. Typically, this corresponds to a write power of 40 mW, with a collimated beam having a diameter of 4 mm, giving a pupil intensity of approximately 80 mW/cm² (approximately a factor of 10 higher than the read intensity). These different intensity beams may be of the same wavelength, or of different wavelengths.

The radiation source 111 emits a radiation beam 112 towards a collimator lens 114, which converts the diverging beam 112 into a collimated beam 115. The collimated beam 115 is incident on an objective system 118. The objective system 118 changes the beam 115 to a converging beam 120, incident on the record carrier 102.

A beam splitter 113 lies in the optical path of the radiation beam that is reflected from the surface of the carrier 102, thus directing a portion of the reflected beam to a detector.

The device 100 further comprises an optical filter 200. Preferably, the optical filter 200 lies in the optical path of the collimated beam 115. Preferably, the optical filter 200 does not lie in the optical path of the beam reflected from the surface of the carrier 102 i.e. in this particular device, preferably the filter 200 lies between the collimated lens 114 and the beam splitter 113.

FIG. 3 shows a more detailed view of the beam splitter 200 of FIG. 2. The filter 200 has an optical axis 119, which in the device shown in FIG. 2 also corresponds to the optical axis of the objective system.

The filter 200 comprises a saturable absorber 206, the absorption of which is arranged to saturate at a predetermined threshold incident radiation intensity, commonly referred to as the saturation intensity. The absorber is selected such that the saturation intensity of the absorber lies between the reading and writing beam intensities (as incident upon the filter). For example, for a collimated (pupil) read intensity of approximately 8 mW/cm², and a writing pupil intensity of approximately 80 mW/cm², then the saturation intensity should be on the order of 10-50 mW/cm². Above the saturation intensity, the transmission of the saturable absorber will increase with higher incident radiation intensities.

In this particular example, so as to provide a rigid support for the absorber, the saturable absorber is formed as a layer upon a transparent substrate. The absorber is used as a spatial filter in the collimated radiation beam 115. In order to have a higher rim-intensity for reading than for writing, the saturable absorber is placed mainly in the centre of the beam. The thickness of the saturable absorber determines the intensity distribution for the read beam, and thus the thickness of the absorption layer (as a function of beam radius i.e. distance from the optical axis) decreases away from the optical axis, the layer being thickest at the optical axis.

As the write beam has a higher intensity than the saturation intensity, the absorption of the beam by the saturable absorber is lowered, and the efficiency of the light path is increased. Consequently, the filter allows the regulation of the intensity profile of the radiation beam, so as to provide a high rim-intensity for reading, whilst still providing an efficient transmissive light path for the writing beam. The filter does not require any active control, but is switched purely by the intensity variation between the read and write beams.

In this particular embodiment, it is desirable that the filter provides a uniform absorption of the write beam. Consequently, a normal absorber (the absorption intensity of which is intensity independent up to at least the write beam intensity) is provided in a ring (204a, 204b) extending around the optical axis, and in this instance overlapping the periphery of the circular layer of saturable absorber 206. The spatial distribution of the saturable absorber and the normal absorber is such that the total absorption profile is uniform for the writing beam intensity, whilst still allowing the desired high rim-intensity for the reading beam.

FIGS. 4A, 4B, 5A and 5B show the performance of the absorptivity of the optical filter (FIGS. 4A and 5A), and how this relates to changing the radiation beam profile (FIGS. 4B and 5B). These figures are plotted as a function of beam radius i.e. distance of the beam from the optical axis 119 of the filter, assuming a total beam width of 2r.

FIGS. 4A and 4B relate to the reading beam, whilst FIGS. 5A and 5B relate to the writing beam. In FIGS. 4B and 5B, the profile of the beam incident upon the filter is indicated by a dotted line, whilst the profile of the beam passed by the filter is indicated by a solid line. It should be noted that the maximum beam intensity of the incident beam (Iₘₐₓ) shown in FIG. 4B is approximately a factor of 10 less than the maximum incident beam intensity of the writing beam shown in FIG. 5B.

As can be seen, when a beam of appropriate intensity for reading (i.e. less than the saturation threshold) is incident upon the filter, the absorption of the filter is non-uniform, and greatest along the optical axis, decreasing with increasing distance from the optical axis. Thus, the incident beam is non-uniformly attenuated, such that the filter passes a relatively flat beam optical intensity profile i.e. a beam with a high rim-intensity, as is desirable for reading.

As shown in FIG. 5A, at the writing beam intensity, the absorptivity of the filter is substantially uniform with radius. Consequently, a low rim intensity is maintained by the passed radiation beam. Further, as the writing beam is above the saturation threshold, the total percentage beam absorption is relatively low, such that the majority of the incident radiation signal is passed by the filter.

It will be appreciated that the above embodiment is provided by way of example only, and that various other embodiments will be understood as falling within the scope of the present invention.

For instance, in the above embodiment the filter is described as having a layer of normal absorber. Such a normal absorption layer can be omitted from the filter, particularly if a non-uniform absorption can be tolerated by the writing beam.

Equally, in the preferred embodiment, the thickness of the saturable absorption layer is described as non-uniform. However, an alternative embodiment of the present invention utilises a uniform thickness saturable absorption layer, but with the density of the saturable absorber within the layer varying as a function of radius i.e. the saturable absorber within the layer being most dense along the optical axis, with the density decreasing as the distance from the axis increases.

The illustrated beam profiles (as shown in FIGS. 1, 4A, 4B, 5A and 5B) are only examples, and the skilled person will appreciate that actual exact beam profiles of other embodiments may be shaped differently. Further, the beam intensities are again provided by way of example only, and may differ substantially in other embodiments. For example, the read beam pupil intensity could be 1 mW/cm², and the write beam intensity 10 mW/cm².

Various compounds for use as saturable absorbers will be apparent to the skilled person, and can be utilised in filters in accordance with the present invention.

For instance, saturable absorption in dyes has very low saturation intensities. The saturation in such dyes is due to the fact that, following optical excitation, the molecules can be excited into the lowest lying triplet energy state, which has a relatively long lifetime. When a molecule is in the triplet state, the molecule can not further absorb incident radiation, and hence becomes optically transparent. Consequently, the saturation intensity in dyes is typically reached when the majority of the molecules are in the triplet state. The saturation intensity of dyes depends upon the absorption cross-section of each molecule and the triplet lifetime, and can be as low as 15 mW/cm².

Alternatively, semiconductors can be implemented as saturable absorbers e.g. in the form of quantum dots formed by sputtering or epitaxially grown. Saturation in semiconductor absorbers corresponds to when the electronic population is in the excited state, or a state in which impurities serve as a trap (thus increasing the lifetime of the state). The lifetimes of such electronic states are generally shorter than the triplet lifetimes of dyes, and thus the saturation intensities are higher.

As well as absolute radiation intensity being used to saturate an absorber, materials can be used in which thermo-chromic effects occur, in which a temperature increase in the material caused by a higher incident intensity beam causes a reduction in the absorption. Such materials are for instance described within the article “Super-resolution rewritable optical disk having a mask layer composed of thermo-chromic organic dye”, by M. Hatakeyma et al., Jpn. J. Appl. Phys., Vol. 39 (2000) pp 752-755.

Whilst the above embodiment has described a scanning device incorporating an optical filter at one particular location in the beam path, it will be appreciated that the filter can of course be placed at other locations within the beam path, or indeed within optical devices configured differently from the device shown in FIG. 2.

FIG. 6 shows a device 1 for scanning an optical record carrier 2, including two alternative positions A and B in which an optical filter could be placed in accordance with an embodiment of the present invention. The record carrier comprises a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 acts as a substrate for the record carrier by providing mechanical support for the information layer.

Alternatively, the transparent layer may have the sole function of protecting the information layer, while the mechanical support is provided by a layer on the other side of the information layer, for instance by the protection layer 5 or by a further information layer and a transparent layer connected to the information layer 4. Information may be stored in the information layer 4 of the record carrier in the form of optically detectable marks arranged in substantially parallel, concentric or spiral tracks, not indicated in the Figure. The marks may be in any optically readable form, e.g. in the form of pits, or areas with a reflection coefficient or a direction of magnetisation different from their surroundings, or a combination of these forms.

The scanning device 1 comprises a radiation source 11 that can emit a radiation beam 12. The radiation source may be a semiconductor laser. A beam splitter 13 reflects the diverging radiation beam 12 towards a collimator lens 14, which converts the diverging beam 12 into a collimated beam 15. The collimated beam 15 is incident on an objective system 18.

The objective system may comprise one or more lenses and/or a grating. The objective system 18 has an optical axis 19. The objective system 18 changes the beam 15 to a converging beam 20, incident on the entrance face 6 of the record carrier 2. The objective system has a spherical aberration correction adapted for passage of the radiation beam through the thickness of the transparent layer 3. The converging beam 20 forms a spot 21 on the information layer 4. Radiation reflected by the information layer 4 forms a diverging beam 22, transformed into a substantially collimated beam 23 by the objective system 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26. A signal processor 27 converts these output signals to various other signals.

One of the signals is an information signal 28, the value of which represents information read from the information layer 4. The information signal is processed by an information processing unit for error correction 29. Other signals from the signal processor 27 are the focus error signal and radial error signal 30. The focus error signal represents the axial difference in height between the spot 21 and the information layer 4. The radial error signal represents the distance in the plane of the information layer 4 between the spot 21 and the centre of a track in the information layer to be followed by the spot.

The focus error signal and the radial error signal are fed into a servo circuit 31, which converts these signals to servo control signals 32 for controlling a focus actuator and a radial actuator respectively. The actuators are not shown in the Figure. The focus actuator controls the position of the objective system 18 in the focus direction 33, thereby controlling the actual position of the spot 21 such that it coincides substantially with the plane of the information layer 4. The radial actuator controls the position of the objective system 18 in a radial direction 34, thereby controlling the radial position of the spot 21 such that it coincides substantially with the central line of track to be followed in the information layer 4. The tracks in the Figure run in a direction perpendicular to the plane of the Figure.

The device of FIG. 2 may be adapted to scan also a second type of record carrier having a thicker transparent layer than the record carrier 2. The device may use the radiation beam 12 or a radiation beam having a different wavelength for scanning the record carrier of the second type. The NA of this radiation beam may be adapted to the type of record carrier. The spherical aberration compensation of the objective system must be adapted accordingly.

In view of the above example, it will be appreciated that embodiments of the invention can be used to provide optical filters for providing a high rim intensity radiation beam suitable for reading, whilst the filter provides a relative efficient light path for writing beams of higher intensity. Further, as the saturable absorber is a passive optical element, embodiments of the invention can be implored without any active control of the filter.

1. An optical scanning device for scanning an information layer of an optical record carrier, the device comprising a radiation source for generating a radiation beam, an objective system for converging the radiation beam on the information layer, and an optical filter for regulating the intensity profile of the radiation beam, the filter having an optical axis and comprising a saturable absorber having an absorption that saturates at a threshold incident radiation intensity, the absorption of the absorber decreasing with distance away from the axis for incident radiation beams of intensity less than the threshold.

2. A device as claimed in claim 1, wherein the saturable absorber is formed in a layer extending substantially perpendicular to the optical axis.

3. A device as claimed in claim 2, wherein said layer is of non-uniform thickness, the thickness of the layer decreasing with distance away from the optical axis.

4. A device as claimed in claim 1, wherein the radiation source is arranged to generate a radiation beam at a first intensity less than said threshold for reading information from the optical record carrier, and a radiation beam at a second intensity greater than said threshold for writing information to said optical record carrier.

5. A device as claimed in claim 1, wherein the optical filter is arranged to have a substantially uniform absorption profile at least one incident radiation intensity greater than said threshold.

6. A device as claimed in claim 5, wherein said at least one beam intensity corresponds to the intensity of a radiation beam suitable for writing information to the optical record carrier.

7. A device as claimed in claim 5, wherein the filter further comprises a layer of absorber that is not saturated at said at least one intensity.

8. An optical filter for regulating the intensity profile of a radiation beam, the filter having an optical axis and comprising a saturable absorber having an absorption that saturates at a threshold incident radiation intensity, the absorber having an absorption that decreases with distance away from the optical axis for incident radiation beams of intensity less than the threshold.

9. A method for manufacturing an optical filter for regulating the intensity profile of a radiation beam, the filter having an optical axis and comprising a saturable absorber having an absorption that saturates at a threshold incident radiation intensity, the absorber having an absorption that decreases with distance away from the optical axis for incident radiation beams of intensity less than the threshold, the method comprising the step of:
forming a non-uniform layer of saturable absorber upon a transparent substrate.

10. A method as claimed in claim 9, wherein said layer is non-uniform in at least one of thickness and density.

11. A method of manufacturing an optical scanning device for scanning an information layer of an optical record carrier, the method comprising the steps of:
providing a radiation source for generating a radiation beam;
providing a lens system for converging the radiation beam on the information layer; and
providing an optical filter or regulating the intensity profile of the radiation beam, the filter having an optical axis and comprising a saturable absorber having an absorption that saturates at a threshold incident radiation intensity, the absorption of the absorber decreasing with distance away from the axis for incident radiation beams of intensity less than the threshold.

12. A method for regulating the intensity profile of a radiation beam using a filter having an optical axis and comprising a saturable absorber having an absorption that saturates at a threshold incident radiation intensity, the absorber having an absorption that decreases with distance away from the optical axis for incident radiation beams of intensity less than the threshold.
